(19) United States
(12) Patent Application Publication
(10) Pub. No.: US 2020/0337324 A1
(43) Pub. Date: Oct. 29, 2020

(54) Plant-Based Whey Protein and Methods for Producing Plant-Based Whey Protein from By-Products and Waste-Streams

(71) Applicant: Innovative Proteins Holding, LLC, North Sioux City, SD (US)

(72) Inventors: Seth A. Foster, Dakota Dunes, SD (US); Tim G. Foster, North Sioux City, SD (US); Donald L. Crank, North Sioux City, SD (US)

(21) Appl. No.: 16/848,000

(22) Filed: Apr. 14, 2020

Related U.S. Application Data
(60) Provisional application No. 62/838,659, filed on Apr. 25, 2019.

(51) Int. Cl. A23C 9/142; A23C 9/12

(52) U.S. Cl. CPC A23C 9/1425; A23C 9/1216; A23C 9/1427

(57) ABSTRACT

Methods for preparation of plant-based whey protein concentrates are provided. Also provided are the plant-based whey protein concentrates made using the methods. The methods utilize an enzymatic reaction to reduce the molecular weight of soluble carbohydrates in a plant-based whey and a single nanofiltration/ultrafiltration and/or diafiltration step to separate soluble non-protein components from the proteins.

### CROSS-REFERENCE TO RELATED APPLICATIONS

The present application claims priority to U.S. provisional patent application No. 62/838,659 that was filed Apr. 25, 2019, the entire contents of which are incorporated herein by reference.

### BACKGROUND

Finding value in waste streams can result in tremendous business opportunities as well as play an important role in improving sustainability and creating competitive advantages. Likewise, companies are constantly looking to improve their bottom line through waste reduction efforts, improvement in operating efficiencies, and maximization of yield recoveries of product and co-product streams.

Food is a significant source of waste. In fact, food is the single largest type of waste thrown away by communities across America, with more than one-third of the food in the United States being lost or wasted each year. Growing, processing, and transporting food consume critical resources. When food is lost or wasted, so are those resources.

Many food processing and manufacturing facilities face food waste related issues. Whey, a by-product of the dairy industry, is an example of a food waste product that has been converted into a valuable commodity. Whey protein has become a household name in the health and sports nutrition industry because of its high nutritional value, fast digestion/adsorption rates, and excellent amino acid profile. However, it has only been in the last 30 years that the dairy industry recognized that this waste stream could be converted into a commercial product. Since then, whey processing technology has been specifically tailored to process this unique dairy by-product stream.

According to Merriam Webster Dictionary, whey is “the watery part of milk that is separated from the coagulable part or curd especially in the process of making cheese and that is rich in lactose, minerals, and vitamins and contains lactalbumin and traces of fat.” Whey is typically a by-product from the cheese and/or yogurt making process and is produced when milk is acidified, rendering the larger molecular casein fraction into a protein curd (cheese curd), while the watery whey comprised of water soluble, low molecular proteins and other macro and micro nutrients are washed away from the precipitated protein curd. Eighty percent of milk proteins are made up of larger molecular weight proteins called casein and 20% lower molecular weight proteins called whey. Some of the protein fractions in whey are classified as “albumins,” e.g., lactoalbumin and serum albumin.

Unlike dairy producers, plant protein producers have not adopted whey as source of protein concentrates. This may be attributed to the fact that carbohydrate content of plant-based whey comprises a diverse and complex mixture of carbohydrates, along with polysaccharides, soluble fibers, and a wide range of other saccharides. By way of illustration, the naturally occurring plant-based whey stream produced from the processing of a commercial pea protein is comprised of a diverse matrix of carbohydrates made up of the following: complex carbohydrates, polysaccharides and soluble fibers (molecular weight range 10,000 Da->1 million Da); oligosaccharides, e.g., verbacose (molecular weight range 828 Da->1,000 Da); tetra-saccharides, e.g., stachyose (molecular weight 667 Da); trisaccharide, e.g., raffinose (molecular weight 504 Da); disaccharides, e.g., sucrose (molecular weight 342 Da); and simple sugars, e.g., glucose (molecular weight 180 Da).

The complex nature of the plant-based whey stream and the need to retain the low molecular protein fraction without also capturing and concentrating the carbohydrates makes plant-based whey protein separation and recovery complex and inefficient. Although separating soluble proteins from such a complex mixture might be tackled using multiple filtration steps with different membranes in combination with other protein separation steps, such as thermocoagulation, such a process would be inefficient and produce a low yield.

The challenges of filtration are compounded by the fact that many factors affect membrane performance, making it difficult to identify appropriate membrane filters for achieving high protein recovery from complex mixtures. Some of the challenges in working to identify the optimal membrane size are best summed up in “Solutions for Improving Water Quality Micro and Nano Technologies, 2014.” “In general, the primary factors that affect the performance of the membranes include the membrane material (charge of the membrane), concentration polarization at the membrane face (buildup of concentration at the membrane face), and fouling of the membrane to name a few. As such, pore size alone does not predict the removal of constituents. Adding more complication to the problem, every manufacturer's membranes are slightly different, meaning there is no simple method for predicting removals.”

In contrast to plant-based whey, dairy whey's carbohydrate composition is made up entirely of a disaccharide sugar, e.g., lactose, having a molecular weight of only 342 g/mol, making the separation and recovery of soluble dairy whey proteins relatively simple and efficient. Other characteristics of plant-based whey add to the complexity, including differences relating to plant-based whey protein's pH solubilities and functional properties relating to heat sensitives and denaturization.

Due to the differences between the content and properties of dairy-based whey and plant-based whey, the procedures, parameters, and process design aspects that have been developed for the successful production of dairy-based whey protein concentrates cannot be applied to production of plant-based whey protein concentrates. Because there has not been a cost effective and efficient method to recover the proteins found in a plant-based whey waste stream, commercial plant protein producers continue to send this valuable by-product and waste stream down the drain. Not only is an opportunity being lost, but many plant protein manufacturers are also likely paying thousands of dollars per day to treat and dispose of this waste stream due to the high levels of nitrogen and ammonia.

### SUMMARY

Methods to produce plant-based whey protein concentrates are provided. One embodiment of such a method includes the steps of: subjecting an aqueous plant-based whey slurry comprising albumin proteins to an enzymatic reaction using alpha amylase, glucoamylase, galactosidase, or a combination of two or more thereof, wherein the enzymatic reaction reduces the molecular weight of carbohydrates in the plant-based whey slurry; conducting a nanofiltration or an ultrafiltration and diafiltration on the plant-based whey slurry to separate plant-based proteins, including albumins, from the slurry; and drying the separated plant-based proteins to form the plant-based whey protein concentrate.

Other principal features and advantages of the invention will become apparent to those skilled in the art upon review of the following drawings, the detailed description, and the appended claims.

### DETAILED DESCRIPTION

Methods for preparation of plant-based whey protein concentrates are provided. Also provided are the plant-based whey protein concentrates made using the methods. In some embodiments of the methods, the source of the whey used to make the concentrates has been produced and recovered from waste generated from typical commercial plant protein concentrate manufacturing processes. For the purposes of this disclosure, protein concentrates have a protein concentration of at least 60% based on dry weights. Protein concentrates include protein isolates, which have a protein concentration of at least 90% based on dry weight.

Various aspects of the inventions described herein were made possible, at least in part, by the inventors' identification of proper procedures and conditions for the separation and concentration of soluble proteins from whey using a single filtration step, which creates tremendous efficiencies through maximizing total protein recovery and eliminating the need for any additional membrane fractionating steps, including preliminary microfiltration, ultrafiltration, and additional protein separation steps, e.g., thermocoagulation or other separation techniques. The single filtration step also removes the need for a secondary reverse osmosis or evaporation concentration step.

Benefits provided by the methods described herein include an optimized process design to provide maximize whey protein recovery; the ability to produce high-value food-grade protein concentrates; and/or an efficient process design that can minimize upfront capital costs, resulting in an adequate or sufficient Return on Investment to justify the recovery process investment and use.

One embodiment of a method for producing a protein concentrate from a whey stream derived from plants includes the steps of: subjecting a plant-based whey slurry in an enzymatic reaction that reduces the molecular weight of the soluble carbohydrates contained therein, followed by a single filtration step to process the enzyme-reacted whey slurry using nanofiltration (NF) or ultrafiltration (UF) and diafiltration (DF) to separate soluble non-protein components from the proteins.

For the purposes of this disclosure, UF and NF are defined as in “Membrane Bioreactor Processes” written by Seong-Hoon Yoon, 2016, specifically in the chapter referenced as “Classification of Membranes According to Pore Size,” as follows: (1) UF (ultrafiltration)—Pore size generally spans 0.01 micron to 0.1 micron, which is measured by prometers. But the pore sizes are often expressed as molecular weight cut off (MWCO) that is measured by filtering surrogate molecules that have known molecular weights. UF MWCO ranges are typically 1,000 Da to 300,000 Da; and (2) NF (nanofiltration)—Pore size might be between 1 nm and 10 nm, but it is not determinable easily since a prometer is no longer effective for this pore size range. NF can effectively remove divalent ions at relatively high efficiency, e.g., 70-99%, but its efficiency of removing monovalent ions such as Na⁺, K⁺, Cl⁻, etc. are typically low at 30-80%. NF MWCO range from 200 Da-1,000 Da depending on operational conditions.

Plant-based whey can be produced from a plant-based “milk”, which is a watery slurry produced when plant particles, such as a milled plant flour, is added to water to form a slurry, followed by the removal of an insoluble carbohydrate fraction rich in starch and fibers. Such plant-based “milk” is similar to a dairy-based milk in that it contains a similar natural ratio of both larger and smaller protein fractions along with other macro and micro-nutrients, e.g., carbs/sugars, minerals, vitamins, and fat. If the plant milk would be further processed into a plant protein concentrate, the plant milk would be acidified similarly as in the dairy cheese making process, resulting in the separation of larger protein fractions, e.g., globular, legumins, and vicillins, to form a plant-based protein curd, the equivalent of non-dairy cheese curd. The remaining soluble liquid fraction from this plant-based curd making process could be classified as plant-based whey.

Wastewater slurries containing low concentrations of plant-based whey proteins discharged from commercial plant protein manufacturing processes can be used as the plant-based whey source for the methods described herein. Such a starting source will contain a wide range of carbohydrate sources and will typically have a dry basis protein concentration of about 10% to 30% weight percent or greater. The proteins present in the slurries will generally include albumin proteins as well as some higher molecular weight proteins that are not captured during the processing of the plant materials from which the slurry is derived, due to inefficiencies of their respective manufacturing procedures and processes, some of which are described in more detail below.

As illustrated in the Example, whey slurries produced from the production of yellow pea protein concentrates are one example of a whey source that can be used. Pea protein is dominated by two classes of proteins, namely albumins and globulins representing 20-30% and 70-80%, respectively, of the total protein found within the seed. (Owusu-Ansah et al., Pea Proteins: A Review of Chemistry, Technology of Production, and Utilization, Food Reviews International, 7(1), 103-134 (1991).) Albumins are considered to be water-soluble metabolic proteins that contain two major fractions with molecular masses of 6 and 25 kDa. Globulins are salt-soluble storage proteins, further subdivided into mainly legumin (300-400 kDa), vicilin proteins (150-170 kDa), and convicilin (70 kDa) proteins. However, whey slurries produced during the production of plant-based protein concentrates from other starting plant raw materials can also be used. These include other pulses such as dried beans, lentils, peas, and other legumes, such as chickpeas, lentils, fava (faba) beans, and mung beans.

These wastewater slurries produced as by-products of plant protein concentration production typically have a pH in the range of 4.5 to 5.5, which is commonly achieved by the addition of a suitable food grade acid like hydrochloric, sulfuric, acetic, citric, nitric, or phosphoric acid near the isoelectric point of the particular raw plant material source. The precipitated protein is then typically collected and concentrated by centrifugation, washed, neutralized, and spray dried.

If the remaining acid whey does not have a pH suitable for the enzymes to reduce the size of the carbohydrates, the pH can be adjusted to a workable or optimal range for the enzymatic reaction. The enzymatic reaction can then be carried out by the addition of food grade glucoamylase, and/or amylase, and/or galactosidase enzyme(s) to the whey slurry. The enzyme(s) selected will be dependent upon the type and quantity of carbohydrates present in the slurry, which will depend upon the raw plant material source. The enzymes are added to reduce the molecular weights of the various carbohydrate fractions present in the wastewater slurry derived from the processing of different plant protein raw materials and to break associations between the protein molecules and such carbohydrates in the slurries. These carbohydrates, including polysaccharides, oligosaccharides, and soluble fibers, are broken down into smaller molecular sizes to facilitate separation from the proteins and for the production of protein concentrates through a single filtration step, as described in more detail below. The pH adjusted slurry with the enzymatic reactions are held for a time as determined by the optimal concentration of the enzyme and reaction conditions and further processed as identified herein.

Optionally, as the carbohydrate enzymatic reactions are nearing completion, the wastewater solution may be fed to a clarifying centrifuge with conditions and at a rate such that the removal of greater than 99.5% of any insoluble material has been accomplished, although lower levels of removal are also acceptable. Solids removed in this clarification step will include any insoluble carbohydrates or precipitated proteins with larger molecular weights that could plug UF or NF membranes. Such insoluble solids clarified from the enzyme-reacted wastewater may be separated and dried as a separate product or added back to the UF or NF retentate and co-dried after the filtration step has been completed.

The resulting clarified and enzyme-reacted wastewater whey solution is then processed in a single filtration step via UF or NF membranes with a molecular weight cutoff of about 500 to 100,000 kDa. The size of the molecular weight cutoff should be such that the carbohydrates will pass through the membrane into the permeate phase, and the majority of the high-quality proteins will be maintained in the retentate. The testing performed by the inventors identified membranes with molecular weight cutoffs of 600-800 Da that will provide the maximum protein recovery while producing retentates with protein concentrations of 70% to >90% dry weight basis in the plant-based whey protein dried powders. Membranes with this molecular weight cutoff are technically NF membranes. In order to maintain high rates of flux in the NF membranes, when the retentate reaches about 8% solids, diafiltration (DF) may be initiated until the permeate is tested to contain 0% solids on a hand held refractometer or CEM moisture analyzer.

Wastewater discharged from a commercial plant-based aqueous protein concentrate production facility will contain some minor levels of non-protein nitrogen and/or ammonia. These nitrogenous compounds will be incorrectly analyzed as protein in the wastewater and will be effectively eliminated from the plant-based whey in the membrane separation process and shall be contained in the permeate. The UF/NF/DF permeate can be discarded into the factory's waste pre-treatment process, discharged for treatment in a municipal wastewater treatment facility, or concentrated and sold as animal feed product.

The plant-based whey protein, which is UF/NF retentate, can then be concentrated in a reverse osmosis membrane or alternatively in an evaporator to achieve a higher solids level to improve the efficiency for drying. The pH of the concentrated retentate will typically be adjusted to 5.5 to 7.5 as desired to create functional characteristics in the proteins. The concentrated retentate is heat treated with time and temperature levels to provide for a 5-log kill step with minimum protein denaturation. Optionally, a two-stage homogenization with 2500/500 psi pressure on the stages is performed to reduce viscosity and shear any protein aggregates that may have formed in the concentration and/or 5-log kill steps. The plant-based whey protein can be dried to a powder in a spray dryer, ring dryer, flash dryer, or other type of drying equipment suited to drying the lower molecular weight protein product. The plant-based whey protein could also be sold as a liquid concentrate for certain applications like the ready-to-drink market and non-dairy beverages/milks.

The plant-based whey protein concentrates and/or isolates produced by the methods described herein typically contain a minimum of 60% protein and a maximum of 100% protein on a dry weight basis. These plant-based whey protein concentrates contain primarily albumin proteins with low molecular weights and superior nutritional properties relating to high bioavailability and rapid absorption capabilities, along with unique functional properties such as low viscosity and low water holding/binding. These proteins are exceptionally well suited in many of the same applications in which dairy-based whey proteins are used, e.g., nutrition bars, ready to drink beverages, meal replacements, and snack/crisp extruded protein applications. Plant-based whey proteins also have a tremendous opportunity to gain acceptance in the sports performance market right alongside diary-based whey proteins. This has been a challenging market for many plant proteins to gain market acceptance.

Described below are various processing techniques for the production of plant-based protein concentrates that also produce whey as a by-product waste stream that can serve as a starting material for the present methods of producing plant-based whey protein concentrates.

Protein concentrates (protein levels of 60% to 90+%) are generally produced commercially using a three-step aqueous processing method that includes protein solubilization, separation of the insoluble components, and separation and concentration of the proteins from other soluble components present in the composition. Protein solubilization is typically accomplished by alkaline extraction (AE) or salt extraction (SE) followed by centrifugal separation to separate insoluble components (mostly starch, sugars, and fiber) in plant (e.g., pea) flour. Separation and concentration of the proteins extracted using AE are accomplished by isoelectric precipitation (IEP) or UF/DF. Separation and concentration of the proteins extracted using SE are performed by protein Micellization (MI) or Dialysis (DI).

The most widely used process in the commercial manufacture of pea and other plant proteins worldwide is AE followed by IEP. In the AE/IEP process, pea proteins are extracted in a water solution by adjusting the pH of the solution with an alkaline hydroxide to solubilize the proteins; then, the soluble proteins and other water-soluble carbohydrates are separated from the insoluble pea fractions by settling, screening, filtering, or centrifugal separation. The resulting soluble stream is further processed by adjusting the pH to the isoelectric point (pH between 4.5 and 5.5) to precipitate the proteins, and the precipitated proteins are collected by centrifugation, washed, neutralized, and spray dried. The non-protein water soluble carbohydrates remaining after centrifugation and washing of the precipitated proteins in the IEP step also contain non-precipitable proteins, mostly albumin and lower molecular weight water soluble proteins. Using terms analogous to dairy terminology, the precipitated proteins (“curds”) are separated from the remaining soluble carbohydrates and albumin and lower molecular weight non-precipitable proteins (“whey”). Approximately 15-25% of the total proteins present in the raw material peas are not collected in this AE/IEP process, and most are located in the “whey” stream, which traditionally has been discharged as process waste and treated in an industrial waste treatment facility.

A variation of the IEP process known as Bacterial Fermentation incorporates the addition of bacterial strains in order to naturally produce lactic acid to reduce the pH to the isoelectric point.

Less widely used processes include SE followed by MI or DI. The SE/MI and SE/DI processes take advantage of the salting-in and salting-out phenomena of proteins followed by a desalting process to lower the ionic strength of the protein environment. Proteins present in the raw peas are solubilized by adding suitable salts; then, these solubilized proteins and other soluble carbohydrates present in the peas are separated from the insoluble fractions in the peas by settling, screening, filtering, or centrifugal separation. In the MI method, protein precipitation is induced by adding cold water to the remaining solution after insoluble separation. Upon reaching a critical protein concentration, proteins form loosely associated protein aggregates also known as micelles, which precipitate from solution and are centrifugally separated and washed from the salt aqueous phase. The salt aqueous phase contains previously extracted soluble non-protein components and other low molecular weight proteins which are not aggregated into the micelles. Approximately 5-20% of the total proteins present in the raw material peas, or other plants, are not collected in this SE/MI process, and most are located in the “whey” stream, which traditionally has been discharged as process waste and treated in an industrial waste treatment facility.

DI is another method for desalting salt soluble extracts. It is a membrane process driven by a chemical potential gradient to diffuse water and low molecular weight solutes across a semipermeable membrane. DI is the least efficient soluble protein separation technique, with approximately 20% to 30% of proteins in the raw peas containing albumin. Other low molecular weight proteins are not collected in this method. This “whey” stream traditionally has been discharged as a process waste and treated in an industrial waste treatment facility.

A final method which has limited commercial utilization is AE followed by UF/DF protein separation. The UF process utilizes membranes with molecular sizing to preferentially separate higher molecular weight proteins (retentate) from non-protein soluble carbohydrates and lower molecular weight proteins (permeate). AE/UF/DF has the potential to capture up to 95% of the proteins present in the raw peas depending upon the molecular weight cutoff of the membrane. DF is a washing step utilized to wash additional non-protein components from the UF retentate. 5 to 15% of the protein in the raw peas will not be captured in the AE/UF/DF process. This “whey” stream also traditionally has been discharged as a process waste and treated in an industrial waste treatment facility.

The waste stream (“whey”) that is discharged from these AE/IEP, AE/UF/DF, SE/MI, and SE/DI processes contains the soluble non-proteins, which comprise mostly carbohydrates present in the raw plants, plus the soluble molecular weight proteins, which comprise mostly albumins. The present methods separate and concentrate the residual proteins, including albumins, into plant-based protein concentrates, which are certainly located in the waste stream from each of these plant protein manufacturing methods.

### Example

Yellow Split Peas were cleaned, dehulled, split, and milled to a 120-mesh flour with lot number 04271810 purchased from Dakota Specialty Milling, Fargo, N. Dak., with as-is analysis of protein 22.2%, ash 2.5%, and acid-hydrolyzed fat 1.8%. 220 lbs. of this flour was slurried into 190 gallons of water at 125° F. with pH adjusted to 8.1 with NaOH (50% concentration) and held for 30 minutes. The extraction slurry was pumped to a Sharples P-660 horizontal decanter to separate the soluble from insoluble materials present in the slurry. The insoluble fraction separated from the slurry had a solids analysis of 33.1% and a protein dry basis analysis of 5.1%. The solubles fraction (extract) separated in the decanter was 4.5% solids, and the dry basis protein analysis was 63.6%. The decanter was operated to achieve 3.0% solids-by-volume of the insoluble material remaining in the solubles fraction. The protein recovery in this AE process followed by the insoluble removal process was 90.0% of the protein present in the raw material.

The pH of the decanted extract was adjusted to a pH of 4.6 with hydrochloric acid (10% concentration) to precipitate the proteins. The precipitated slurry was fed to a Sharples P-660 decanter to separate precipitated protein (curds) from the acid whey. The precipitated and separated curds had a solids level of 9.2% and a protein dry basis of 76.5%, and the whey had a solids level of 2.2% and a protein dry basis of 30.9%. 86.4% of the protein present in the extract was contained in the precipitated and separated protein curds. 77.4% of the protein contained in the raw material was contained in the final pea protein concentrate, and 23.6% of the protein contained in the raw material was in the process waste water from this AE/IEP process. The protein curds are typically treated with caustic to neutral pH, heat treated, and dried. The dried curd protein process represents the current production methods used to produce the majority of the pea proteins sold worldwide. In this trial, the final pea protein concentrate was discarded.

A glucoamylase (Enzyme Development Glucoamylase AN) was added to the acid whey stream and held for approximately 120 minutes.

The pH of the acid whey was then adjusted to 5.5 with NaOH (10% solution) and then pumped to a Westfalia SB-7 clarifier to remove residual precipitated protein curds, and this clarified acid whey had a residual level of less than 0.25% solids by volume in a laboratory centrifuge.

The clarified and glucoamylase-treated acid whey was processed with a UF system outfitted with a 3,000 Dalton PES membrane to a solids level of about 8%, then diafiltered with water in the amount equal to approximately 50% of the volume of the starting acid whey or until 0% solids from the permeate was achieved via refractometer or CEM moisture analyzer. The retentate from the DF operation was 2.3% solids and was analyzed to contain 81.9% dry basis protein, and the permeate contained 0.7% solids with an analysis of 23.2% dry basis protein. 65.0% of the protein contained in the clarified acid whey was recovered in this DF processing step. The amount of protein recovered in the diafiltered acid whey retentate was 15.3% of the protein contained in the raw material pea flour thus processed. The waste slurry from the AE/IEP process was processed with this invention to recover small molecular weight proteins, which were mostly albumins present in the whey.

The final retentate was evaporated in a pilot-sized evaporator to about 19% solids, vat pasteurized at 160° F. for 10 minutes, cooled to <140° F., homogenized in a two-stage Manton Gaulin homogenizer with 2500/500 psi pressure, and spray dried in a NIRO atomizing wheel pilot spray drier with an inlet temperature of 185° C. and an exhaust temperature of 95° C. The final product was a plant-based whey protein concentrate that was analyzed to contain 80.5% dry basis protein, 0.7% acid hydrolyzed fat, 2.8% ash, 16.0% carbohydrates, and 5.3% moisture.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method of making a plant-based whey protein concentrate comprising:
subjecting an aqueous plant-based whey slurry comprising albumin proteins to an enzymatic reaction using alpha amylase, glucoamylase, galactosidase, or a combination of two or more thereof, wherein the enzymatic reaction reduces the molecular weight of carbohydrates in the plant-based whey slurry; and
conducting a nanofiltration or an ultrafiltration and diafiltration on the plant-based whey slurry to separate plant-based proteins, including albumins, from the slurry.

2. The method of claim 1, further comprising drying the separated plant-based proteins.

3. The method of claim 1, wherein the aqueous plant-based whey slurry is a waste stream generated during the production of a plant protein concentrate.

4. The method of claim 1, wherein the plant-based whey protein concentrate is a pulse-based whey protein concentrate.

5. The method of claim 4, wherein the pulse-based whey protein concentrate is a yellow pea-based whey protein concentrate.

6. The method of claim 3, wherein the plant-based whey protein concentrate is a pulse-based whey protein concentrate.

7. The method of claim 6, wherein the pulse-based whey protein concentrate is a yellow pea-based whey protein concentrate.

8. The method of claim 6, further comprising adjusting the pH of the yellow pea-based whey slurry to optimize the performance of the enzymes used in the enzymatic reaction.

9. The method of claim 1, further comprising adjusting the pH of the plant-based whey slurry to optimize the performance of the enzymes used in the enzymatic reaction.

10. The method of claim 1, comprising clarifying the aqueous plant-based whey slurry via settling, screening, centrifugation, or a combination thereof, prior to conducting the nanofiltration or the ultrafiltration and diafiltration.

11. The method of claim 1, further comprising conducting a reverse osmosis on the separated plant-based proteins.
